(19) United States
(12) Patent Application Publication
(10) Pub. No.: US 2020/0370721 A1
(43) Pub. Date: Nov. 26, 2020

(54) Safety Light

(71) Applicants: Richard Scholl, Cape Coral, FL (US); Peter Wahl, Cape Coral, FL (US)

(72) Inventors: Richard Scholl, Cape Coral, FL (US); Peter Wahl, Cape Coral, FL (US)

(21) Appl. No.: 16/868,615

(22) Filed: May 7, 2020

Related U.S. Application Data
(60) Provisional application No. 62/850,007, filed on May 20, 2019.

(51) Int. Cl. F21S 8/08; F21V 31/00; F21S 9/03; F21V 23/04; F21S 10/06

(52) U.S. Cl. CPC F21S 8/086; F21V 31/00; F21W 2111/023; F21V 23/0471; F21S 10/06; F21S 9/037

(57) ABSTRACT

Disclosed is a light that includes a light emitting device having at least one downlight and at least one sidelight. The light also includes a power source configured to provide power to the at least one downlight and the at least one sidelight. In example embodiments, a power system utilizing the power source may include a controller configured to control power flowing from the power source to the at least one downlight and the at least one sidelight and using a timer configured to control how long power will be provided. The light may further include at least one solar cell configured to recharge the power source, and a switch operably connected to the power system so then when the switch is operated the power system routes power to at least at least one downlight and the at least one sidelight.

### CROSS-REFERENCE TO RELATED APPLICATION(S)

This application claims the benefit of U.S. Provisional Patent Application No. 62/850,007 which was filed with the United States Patent and Trademark Office on May 20, 2019 the entire contents of which are herein incorporated by reference.

### BACKGROUND

### 1. Field

Example embodiments relate to a light which functions as a safety light, for example, a bus stop safety light.

### 2. Description of the Related Art

School buses are commonly used to transport children to and from school. Generally speaking, the children are picked up at a designated spot before school, driven to school, and then returned to the designated spot after school. At times the designated spots are located at areas with very poor to no lighting. This means the children may be picked up and/or dropped off at an area which is relatively dark. Waiting in an area with little to no lighting places the children at risk since they are often not visible to drivers who may be inadvertently driving by the designated spot.

### SUMMARY

The inventor, concerned with children's safety at school bus stops, set out to solve a safety issue involving children waiting at a designated stop that does not have adequate lighting. As a result, the inventor invented a new safety light which is usable at bus stops. The inventor, however, has found multiple uses of the new safety light, thus, the invention should not be limited to school bus stops. For example, the inventor has noticed the new safety light may be used as an inexpensive source of light for parties in third world countries and/or may be used to provide lighting in disaster regions. Though the examples generally disclosed in this application are directed to use as a safety light at bus stops it may have several uses including, but not limited to, providing on demand lighting at boat ramps.

In accordance with example embodiments, a light may include a light emitting device having a weather proof housing enclosing a power system, the light emitting device including at least one downlight configured to project light to the ground and at least one sidelight configured to emit light laterally, a boom connected to the weather proof housing, the boom being configured to attach the light emitting device to a structure.

Disclosed is a light that includes a light emitting device having at least one downlight and at least one sidelight. The light also includes a power source configured to provide power to the at least one downlight and the at least one sidelight. In example embodiments, a power system utilizing the power source may include a controller configured to control power flowing from the power source to the at least one downlight and the at least one sidelight and using a timer configured to control how long power will be provided. The light may further include at least one solar cell configured to recharge the power source, and a switch operably connected to the power system so then when the switch is operated the power system routes power to at least one of the at least one downlight and the at least one sidelight.

### BRIEF DESCRIPTION OF THE DRAWINGS

Example embodiments are described in detail below with reference to the attached drawing figures, wherein:

FIG. 1 is a view of a safety light in accordance with example embodiments;

FIGS. 2A and 2B are a close-up views of a light emitting device in accordance with example embodiments;

FIG. 3 is another close-up view of the light emitting device in accordance with example embodiments;

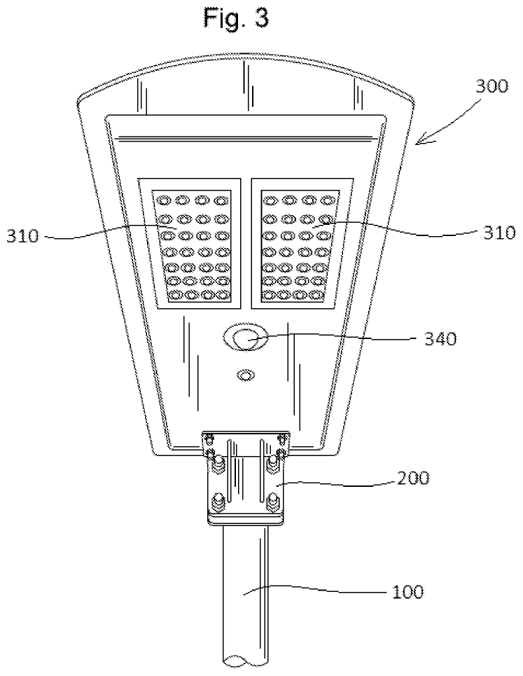

FIG. 4 is a top view of the light emitting device in accordance with example embodiments;

FIG. 5 is a view of a power system in accordance with example embodiments;

FIGS. 6A-6D show various ways of supporting the safety light in accordance with example embodiments; and

FIG. 7 is a view of another power system in accordance with example embodiments.

### DETAILED DESCRIPTION

Example embodiments will now be described more fully with reference to the accompanying drawings. Example embodiments are not intended to limit the invention since the invention may be embodied in different forms. Rather, the example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature only as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a light which may serve as a safety light and which may be used as a safety light at a bus stop.

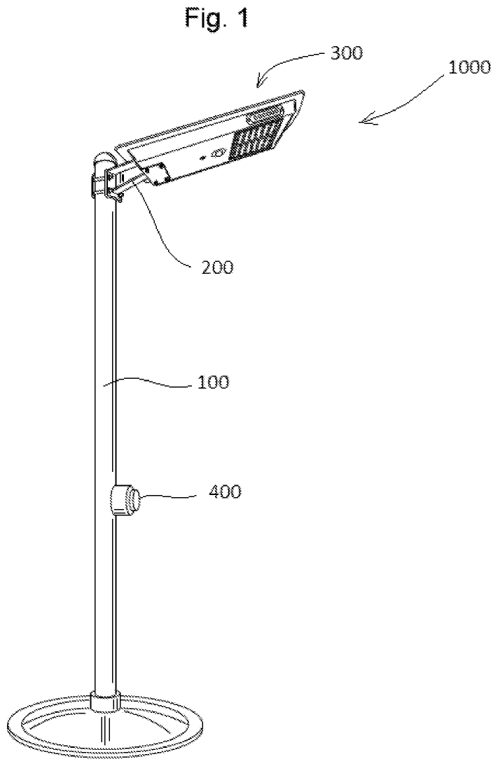

FIG. 1 is a view of a light 1000 in accordance with a nonlimiting example of the invention. As shown in FIG. 1, the light 1000 includes a pole 100, a boom 200, a light emitting device 300, and a switch 400. In this particular nonlimiting example embodiment the switch 400 may be used to turn the light emitting device 300 on to illuminate an area below the light emitting device 300. In one nonlimiting example embodiment, the switch 400 may be an ADA paddle switch.

In example embodiments, the light 1000 may serve several purposes and may be configured for a particular purpose. For example, when the light 1000 is intended for outdoor use, it may be desirable to manufacture the elements of the light 1000 to resist various weather conditions, for example, heat, cold, water, wind, snow, and ice. In this particular example, the pole 100 may be a galvanized metal pole, an aluminum pole, or some other type of pole configured to withstand typical weather conditions. For example, it is anticipated that other materials, for example, a lightweight fiber glass material, may alternatively be used. Similarly, the boom 200 may also be made from a relatively durable material capable of withstanding the effects of the environment. As such, the boom 200 may also be made from a galvanized metal material, aluminum, or some other material, such as a lightweight fiber glass material.

In example embodiments a cross-section of the pole 100 may take one or more shapes. For example, in one embodiment, the pole 100 is fabricated from a square or rectangular tube, for example, square or rectangular tube steel. In another embodiment, the cross-section of the pole 100 is annular. In yet another embodiment, the cross-section of the pole 100 may resemble an I or C shape. In short, a cross-section of the pole 100 may take several shapes without departing from the inventive concepts described herein. Similarly, the boom 200 may also take on many shapes including, but not limited to, those cited above.

Typically, the pole 100 is long enough to provide a proper elevation for the light emitting device 300. To that end, pole lengths of about 12 feet to 15 feet and 2 and ⅜ inches are generally acceptable. However, the length may be longer or shorter depending on the use of the light emitting device 300.

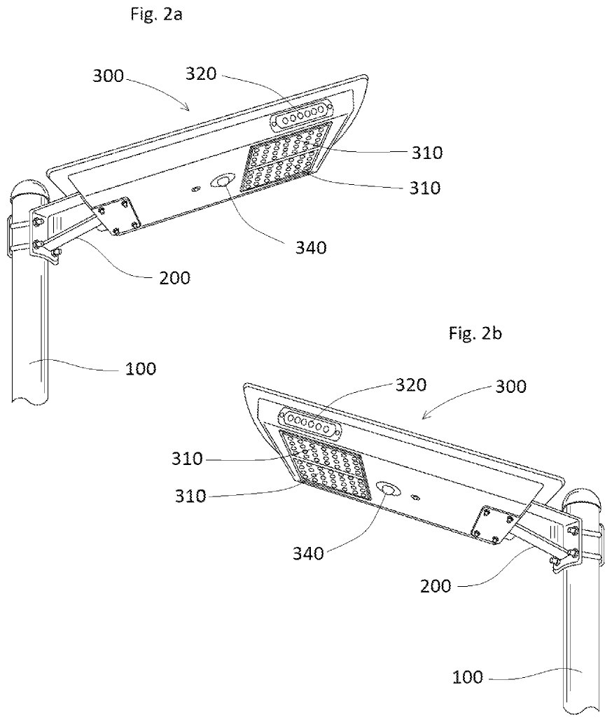

In example embodiments, the light emitting device 300 may include one or more downlights 310 (see FIGS. 2A and 2B) configured to provide light downward to illuminate an area around and below the light 1000. The downlight 310, for example, may be comprised of one or more light emitting diodes. The downlight 310 may illuminate an area where one or more pedestrians may stand to make the pedestrians visible. In one nonlimiting example embodiment, the downlight is a 30 W 50K solar LED 3000 Lumen light capable of generating light in about a 20 foot radius. The light emitting device 300 may also include sidelights 320 to make the light 1000 even more noticeable. The sidelights 320 may, in one embodiment, be strobe lights arranged on sides of the light emitting device making the light 1000 even more noticeable by drivers who may be driving by the light 1000. For example, strobe lights may emit amber and white light in pulses which can more easily grab a driver's attention than a nonpulsing light.

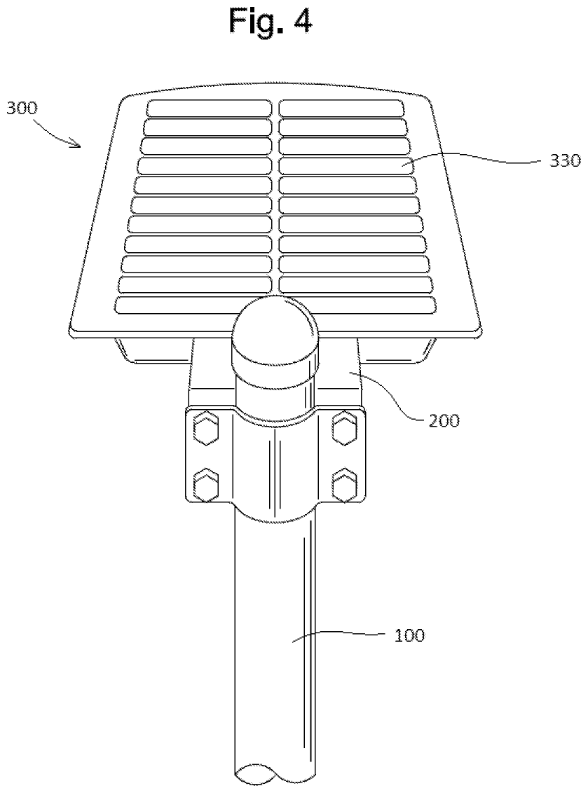

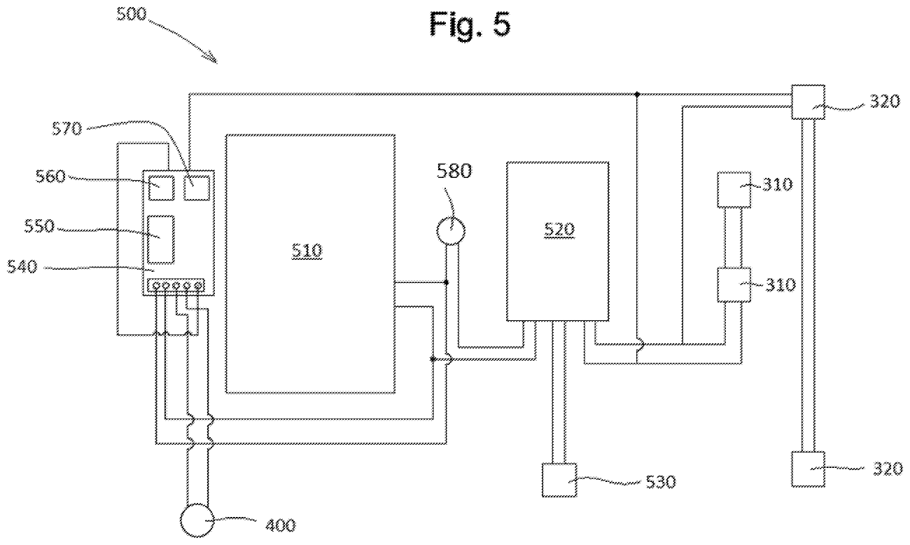

In example embodiments, the light 1000 may be placed in a location where power is not readily available. As such, the light 1000 may be equipped with a power supply 510 (see FIG. 5), for example, a battery, to power the light 1000. In one nonlimiting example embodiment, the power supply 510 may be an 8800 mAh large capacity lithium battery. In addition, the light 1000 may further include solar cells 330 (see FIG. 4) which may charge the power supply 510 thus increasing the service life of the light 1000. For example, in the nonlimiting example embodiment of FIG. 4, the light emitting device 300 may be fabricated with a weather proof housing having a collection of solar cells 330 arranged at a top there of. The solar cells 330 may charge a battery 510 (an example of a power source) that may be arranged inside a housing of the light emitting device 300.

In example embodiments, the light 1000 may further include a motion sensor 340 which may sense whether one or more people are in the vicinity of the light 1000. The motion sensor 340, in one embodiment, may be integrated with the light emitting device 300. In this embodiment, the downlight 310 and the sidelights 320 may turn on when the motion sensor 340 detects motion near or under the light emitting device 330. The inclusion of a motion sensor 340 may provide the advantage of turning on the light 1000 without the need to use the switch 400. In example embodiments, the motion sensor 340 may be integrated with the light emitting device 300, however, the motion sensor 340 is not required to be integrated with the light emitting device 300 as it may be placed outside of the housing of the light emitting device 300.

It is understood that the incorporation of a motion sensor 340, while in some embodiments, is quite useful, in other embodiments is not useful and even detracts from the usefulness of the light 1000. For example, it may be desired to have a light 1000 which is not activated based on detected motion since detected motion may be associated with people having no use for the light 1000, for example, people merely walking by the light, or even animals. Thus, having a light 1000 turn on based on a motion could be detrimental to the light 1000 in that it may cause the light's power source to drain unnecessarily. In addition, activating the light 1000 when it is not need could also act as a nuisance. As such, the inventive concepts cover a light 1000 which does not include the aforementioned motion sensor 340 or a light 1000 which allows the motion sensor 340 to be easily deactivated. In one exemplary embodiment, when the motion sensor 340 is not incorporated into the light 1000, or the motion sensor 340 is deactivated, the light 1000 operates as an on-demand system where a user, for example, a child, activates the light by pressing the switch 400.

In the various nonlimiting example embodiments, the boom 200 may be integral with the pole 100. For example, the boom 200 may be welded to the pole 100. On the other hand, the boom 200 may be configured to removably attach to the pole 100. For example, a boom 200 may be configured as a bracket which may removably attach the boom 200 to the pole 100 and allow some flexibility regarding the placement of the boom 200 on the pole 100. For example, when the boom 200 is used to attach the light emitting device 300 to the pole 100, a user has the option to place the boom 200 anywhere along the pole's length LP thus allowing for an adjustability of the height of the light emitting device 300. In other words, the boom 200 allows for some adjustability regarding the height of the downlight 310 and the sidelights 320. In addition, having the boom 200 separate from the pole 100 allows the light emitting device 300 to be supported from some structure other than a pole. For example, some bus stops already have shelters, however, not all of the shelters have a light associated with them. Example embodiments anticipate the light emitting device 300 being attachable to the shelter via the boom 200 to provide the needed light. In fact, the light emitting device 300 may be attachable to a plurality of structures, for example, existing poles, buildings, water towers, and cranes to provide light. Thus, while a pole 100 is certainly useful, the pole 100 is not required to practice certain inventive concepts disclosed herein.

FIG. 5 is a view of an electrical schematic of a power system 500 that may be arranged in the housing of the light emitting device 300. As shown in FIG. 5, the power system 500 may include a battery 510 which may power the system 500. The battery 510, for example, may be a 12 Volt rechargeable battery. The system may further include an all-in-one solar charger-motion sensor-LED Driver 520. As shown in FIG. 5, all-in-one solar charger-motion sensor-LED Driver 520 may connect to the solar cells 330 via a solar panel connector 530. Thus, the battery 510 may be recharged by the all-in-one solar charger-motion sensor-LED Driver 520 which in turn may receive power from the solar cells 330. In this way, the battery 510 may be routinely charged to power the system 500.

In example embodiments, the power system 500 may include a controller 540 with a built-in timer 550, a contact 560, and a relay 570. The controller 540 may be connected to the switch 400 so that operation of the switch 400 will cause power to flow from the battery 510 to the sidelights 320 and the downlights 310. The timer 550 will shut power off the sidelights 320 and downlight 310 after a preset time in order to preserve the battery life. For example, the timer 550 may be configured to shut power off after 5, 10, 15, 20 minutes after the switch 400 has been actuated. These time values, however, are for the purpose of illustration only and are not intended to limit the invention as the timer 550 may be configured to turn off power to the sidelights 320 and the downlight 310 at any predetermined time value.

In example embodiments, the all-in-one solar charger-motion sensor-LED Driver and motion sensor 520 may be configured to route power to the sidelights 320 and downlight 310 when motion is detected by the motion sensor built into the all-in-one solar charger-motion sensor-LED driver 520. Power may continue to flow provided the motion sensor detects motion. This allows for pedestrians to walk up to the light 1000 and have the sidelights 320 and downlights 310 activate without operating the switch 400. In example embodiments the power system 500 may include a light detector 580 that may be configured to detect ambient light. If the ambient light detected by the light detector 580 is bright enough so that pedestrians near the light 1000 can be easily seen without the need of the downlight 310 and sidelights 320, the power to the downlight 310 and sidelights 320 may be prevented in order to preserve battery life of the battery 510 and increase the rate at which the battery 510 is recharged. In the alternative, power to the downlights 310 may prevented while still allowing power to flow to the sidelights 320 when motion is detected or the switch 400 is operated.

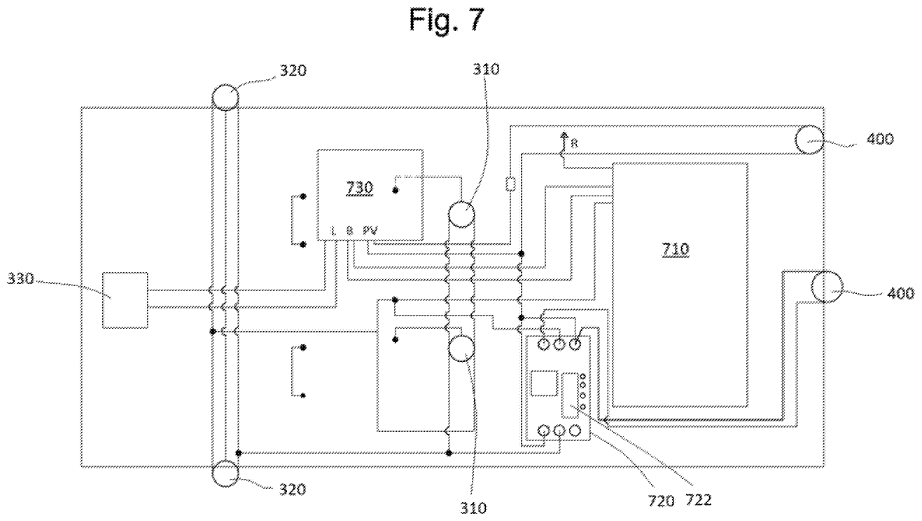

It is understood that the invention is not strictly limited to what has been disclosed and the inventive concepts can be expressed in many ways. For example, the power system 500 previously described is not meant to limit the invention. For example, FIG. 7 is a view of another power system 700 which may be used in lieu of power system 500 to power the light 1000. As shown in FIG. 7, the power system 700 may include a battery pack 710 to power the downlights 310 and the sidelights 320. Included in power system 700 is a control panel 720 which may include a timer 722 which may be used to control how long light 1000 will emit light. The timer 722, for example, may control the light 1000 to emit light (for example, light from the downlight 310 and sidelights 320) for 5 minutes, 10 minutes, 20 minutes, or whatever time limit is desired. The power system 700 may further include a charger 730, for example, an SDN-P solar charge controller, which may be connected to the solar cells 330. The charger 730 may charge the battery pack 710.

In example embodiments the battery pack 710 (an example of a power supply) may provide power to the downlight 310 and the sidelights 320. For example, if a person were to actuate the switch 400 the control panel 720 would route power to the downlight 310 and sidelights 320 and continue providing power for the time limit set by the timer 722. As another example, if a person were to walk within a vicinity of the light 1000 and was detected by the motion sensor 340, the control panel 720 would route power from the battery pack 710 to downlight 310 and sidelights 320. Of course, in examples where the motion sensor 340 is not incorporated into the light 1000, the light 1000 would not turn on when a person walks in the vicinity of the light and the control panel 720 would not route power from the battery pack 710 to the downlight 310 and sidelights 320.

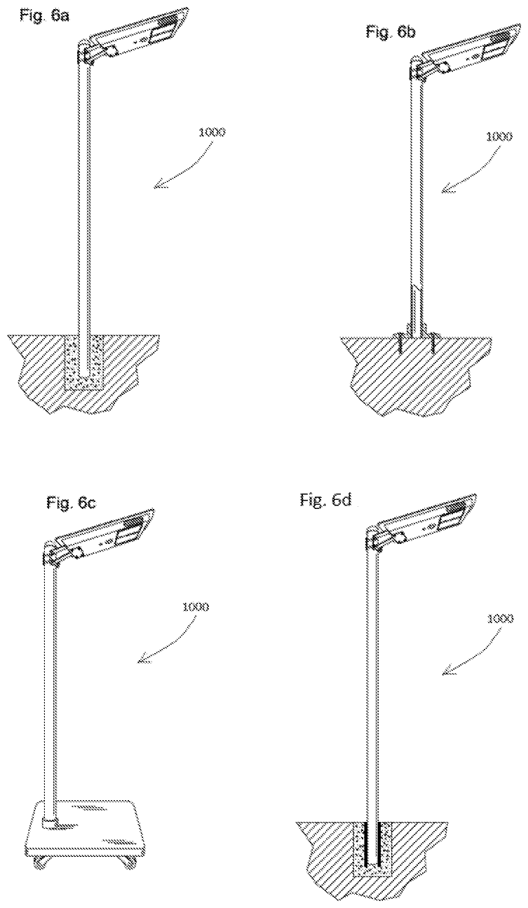

In example embodiments, the light 1000 may be installed in multiple ways. For example, FIG. 6A illustrates a bottom of the pole 100 buried in the ground. In this nonlimiting example embodiment, a hole may be dug into the ground and concrete may be poured in the ground. Thereafter, an end of the pole 100 may be inserted into the concrete before it cures in order to provide a solid foundation for the light 1000. Of course, concrete is not necessary as a hole may be dug into the ground the end of the pole 100 may be inserted into the hole which is thereafter filled with soil to keep the pole in place. Another alternative is with a sleeve embedded into the ground surrounded by concrete, as shown in FIG. 6D so the pole 100 may be inserted into the sleeve. This way the light can be re-located at any given time. As yet another example, if the bus stop is located near a concrete slab, a flange may be attached to the concrete slab with anchor bolts drilled into the concrete to retain the flange as shown in FIG. 6B. An end of the pole 100 may thereafter be connected to the flange via a conventional means, for example, screws, pins, clips, and/or welding, to secure the pole to the flange. As yet another example, an end of the pole 100 may be fitted with a wheeled platform which allows the light 1000 to be easily moved from one location to another as shown in FIG. 6C. This latter embodiment may be helpful in emergency situations where emergency lighting may be desired, for example, after a flood where rapid deployment of mobile lights is desired.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A light comprising:
a light emitting device having a weather proof housing enclosing a power system, the light emitting device including at least one downlight configured to project light to the ground and at least one sidelight configured to emit light laterally; and
a boom connected to the weather proof housing, the boom being configured to attach the light emitting device to a structure.

2. The light of claim 1, wherein the at least one downlight is a plurality of LED lights.

3. The light of claim 1, wherein the at least one downlight is a 30W 50k solar LED 3000 Lumen light configured to light approximately at twenty foot radius.

4. The light of claim 1, wherein the at least one sidelight is a strobe light.

5. The light of claim 1, wherein the at least one sidelight emits white and amber lights.

6. The light of claim 1, wherein the at least one sidelight emits a pulsing white and amber light.

7. The light of claim 1, further comprising:
a pole, wherein the boom attaches the weather proof housing to the pole.

8. The light of claim 7, wherein the boom is removably attached to the pole.

9. The light of claim 1, wherein the power system includes a timer configured to control a duration of light emitted by at least one downlight and the at least one sidelight.

10. The light of claim 1, further comprising:
solar cells on the top of the weather proof housing, the solar cells configured to recharge a battery of the power system.

11. The light of claim 1, further comprising:
a pole, wherein the boom is removably attached to the pole and an end of the pole is in the ground.

12. The light of claim 1, further comprising:
a pole, wherein the boom is removably attached to the pole and an end of the pole is attached to a flange which is connected to the ground.

13. The light of claim 1, further comprising:
a pole, wherein the boom is removably attached to the pole and an end of the pole is supported by a wheeled platform.

14. The light of claim 1, further comprising:
a switch configured to turn on the at least one downlight and the at least one sidelight when the switch is manually operated.

15. The light of claim 1, further comprising:
a motion sensor configured to sense a person proximate to the light emitting device and turn on the at least one downlight and the at least one sidelight when the person is sensed.

16. A light comprising:
a light emitting device having at least one downlight and at least one sidelight;
a power source configured to provide power to the at least one downlight and the at least one sidelight;
a power system including a controller configured to control power flowing from the power source to the at least one downlight and the at least one sidelight, the power system including a timer configured to control how long power will be provided to the at least one downlight and the at least one sidelight;
at least one solar cell configured to recharge the power source; and
a switch operably connected to the power system so then when the switch is operated the power system routes power to at least one of the at least one downlight and the at least one sidelight.

17. The light of claim 16, further comprising:
a motion sensor operably connected to the controller such that if the motion sensor detects a person near the light the controller will route power to at least one of the at least one downlight and the at least one sidelight.

18. The light of claim 16, further comprising:
a pole and the light emitting device is removably connected to the pole.

19. The light of claim 16, wherein the power system and the power source are enclosed by a weatherproof housing.

20. The light of claim 19, wherein the at least one downlight is configured to emit light through a bottom of the housing or from the bottom of the housing and the at least one sidelight is configured to emit light through a side wall of the housing or from a sidewall of the housing.
